(19) United States
(12) Patent Application Publication
(10) Pub. No.: US 2002/0122407 A1
(43) Pub. Date: Sep. 5, 2002

(54) Methods, communication apparatus, and computer program products for detecting an information field in a signal by averaging symbol values across multiple time slot intervals

(76) Inventors: Karl J. Molnar, Cary, NC (US); Huseyin Arslan, Durham, NC (US); Abdulrauf Hafeez, Cary, NC (US); Rajaram Ramesh, Cary, NC (US)

Correspondence Address: MYERS BIGEL SIBLEY & SAJOVEC, PO BOX 37428, RALEIGH, NC, 27627, US

(21) Appl. No.: 10/001,604

(22) Filed: Oct. 31, 2001

Related U.S. Application Data
(63) Continuation-in-part of application No. 09/747,344, filed on Dec. 22, 2000.

(51) Int. Cl. H04J 3/00; H04B 7/212

(52) U.S. Cl. 370/347; 370/336

(57) ABSTRACT

Methods, communication apparatus, and computer program products process a signal by detecting an information field therein. A signal may be received across a plurality of time slot intervals with each time slot interval including a plurality of symbol positions so as to provide a sequence of symbols associated with the received signal. An average value of the symbols received in a symbol position across the plurality of time slot intervals is determined. A determination may be made whether a symbol position contains a fixed symbol based on the average symbol value determined for that symbol position. Alternatively, a determination may be made whether the received signal contains symbols corresponding to a predefined symbol sequence based on the average values respectively determined for the plurality of symbol positions.

### CROSS REFERENCE TO RELATED APPLICATION

This application is a continuation-in-part of U.S. application Ser. No. 09/747,344, filed Dec. 22, 2000, the disclosure of which is hereby incorporated herein by reference.

### BACKGROUND OF THE INVENTION

The present invention relates generally to the field of data communication, and, more particularly, to methods, communication apparatus, and computer program products for detecting an information field in a signal.

Joint demodulation may be used to handle co-channel interference in communication systems. In systems that use coherent detection (e.g., Telecommunication Industry Association (TIA)/Electronic Industries Association (EIA)/American National Standards Institute (ANSI) 136 standard systems), communication channel estimates are generally obtained to facilitate demodulation of an incoming signal. In conventional, single-user demodulation systems, channel estimates may be obtained through use of a known training sequence, such as a synchronization (sync) sequence, which may be used to obtain time slot and signal sample timing. Ideally, for joint demodulation, initial channel estimates may be obtained for all incoming signals-desired and interfering-if the respective training sequences are known and time aligned for each signal. If the training sequences are time aligned, then the training sequences may further be designed to be orthogonal to one another so that they are non-interfering. If the training sequences are known, but are time misaligned, however, then the channel estimates obtained for each signal may be less accurate because partial overlap between the training sequences may result in interference therebetween.

In ANSI 136 time division multiple access (TDMA) communication systems, the particular sync sequence used by an interfering signal is generally not known, and it may be prohibitively complex to search through all possible sync sequences that may be used by the interfering signal to find a match. As a result, semi-blind techniques may be used to estimate an interfering signal's channel, which techniques typically use only the training sequence of the desired signal. Initial channel estimation using semi-blind techniques is, however, generally not as good as the channel estimate that may be obtained when the sync sequences are known and time aligned for both the desired signal and the interfering signal. While it is generally possible to improve the interfering signal's channel estimates, such improvement is typically accompanied by a higher computational cost than would be incurred if the interfering signal's sync sequence were known.

For example, conventional semi-blind demodulation techniques may use the training sequence of the desired signal to obtain the channel estimate for the interfering signal under slow fading conditions. Using the desired signal's training sequence, the desired signal's channel may be trained while simultaneously demodulating the interfering signal and obtaining an initial estimate of the interfering signal's channel. At the beginning of the demodulation process for the interfering signal, the interfering signal's channel estimate may not be highly reliable; however, the reliability of the interfering signal's channel estimate generally improves once the training process is completed. The foregoing training process may be computationally intensive inasmuch as the interfering signal's delay and channel are estimated simultaneously. Multiple survivor search techniques and/or multiple pass techniques may be used to improve estimation of the interfering signal's channel.

An alternative to semi-blind channel estimation may involve searching for the sync sequence used by an interfering signal in a similar manner that is used to demodulate a desired signal. One approach may involve correlating a received signal with sync sequences contained in a library of possible sync sequences. Unfortunately, this approach may be computationally intensive because the number of possible sync sequences may be large and the starting and stopping points of a sync sequence in the interfering signal are not known. Accordingly, the correlation operations may need to take into account many different sync sequence starting points within a time slot and may also need to account for portions of a sync sequence spanning multiple time slots as the timing of the interfering signal may not coincide with the timing of the desired signal. The correlation operations for detecting a sync sequence in an interfering signal may be further complicated by receipt of the desired signal, which typically has a higher power level. Even if the desired signal is subtracted out, correlating an interfering signal with possible sync sequences may be computationally complex.

In single-user demodulation systems, channel tracking following training based on a sync sequence may be used for channels that fade rapidly. For example, in an ANSI 136 TDMA system, the fading may be fast enough and the time slot duration may be long enough that channel estimates may be tracked over a single time slot. To improve detection performance, known and highly reliable sequences may be used for retraining the channel estimates. One highly reliable sequence that is used in ANSI 136 TDMA systems is known as the coded digital verification color code (CDVCC) sequence. Once the CDVCC sequence has been detected and verified correct, it can be used for retraining the channel estimates. Unfortunately, in joint demodulation systems, there is typically no known information about the interfering signal apart from its mere presence even though sequences, such as a CDVCC sequence, may be present in the signal. As a result, there typically are no reliable sequences known to the receiver that may be used to retrain the channel estimates for the interfering signal.

### SUMMARY OF THE INVENTION

Embodiments of the present invention include methods, communication apparatus, and computer program products for processing a signal by detecting an information field therein. A signal may be received across a plurality of time slot intervals with each time slot interval including a plurality of symbol positions so as to provide a sequence of symbols associated with the received signal. An average value of the symbols received in a symbol position across the plurality of time slot intervals is determined. A determination may be made whether a symbol position contains a fixed symbol based on the average symbol value determined for that symbol position. Alternatively, a determination may be made whether the received signal contains symbols corresponding to a predefined symbol sequence based on the average values respectively determined for the plurality of symbol positions.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a schematic of an exemplary radiotelephone communication system including detection of an information field in a signal by averaging symbol values across multiple time slot intervals in accordance with embodiments with the present invention;

FIGS. 2-4 are block diagrams of receivers for detecting an information field in a signal by averaging symbol values across multiple time slot intervals in accordance with further embodiments of the present invention;

FIG. 5 is a block diagram of a fixed field/sequence detection unit for detecting an information field in a signal by averaging symbol values across multiple time slot intervals in accordance with embodiments of the present invention; and

FIGS. 6-11 are flowcharts illustrating exemplary operations for detecting an information field in a signal by averaging symbol values across multiple time slot intervals in accordance with embodiments of the present invention.

### DETAILED DESCRIPTION OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

The present invention may be embodied as methods, communication apparatus, and/or computer program products. Accordingly, the present invention may be embodied in hardware and/or in software (including firmware, resident software, micro-code. etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

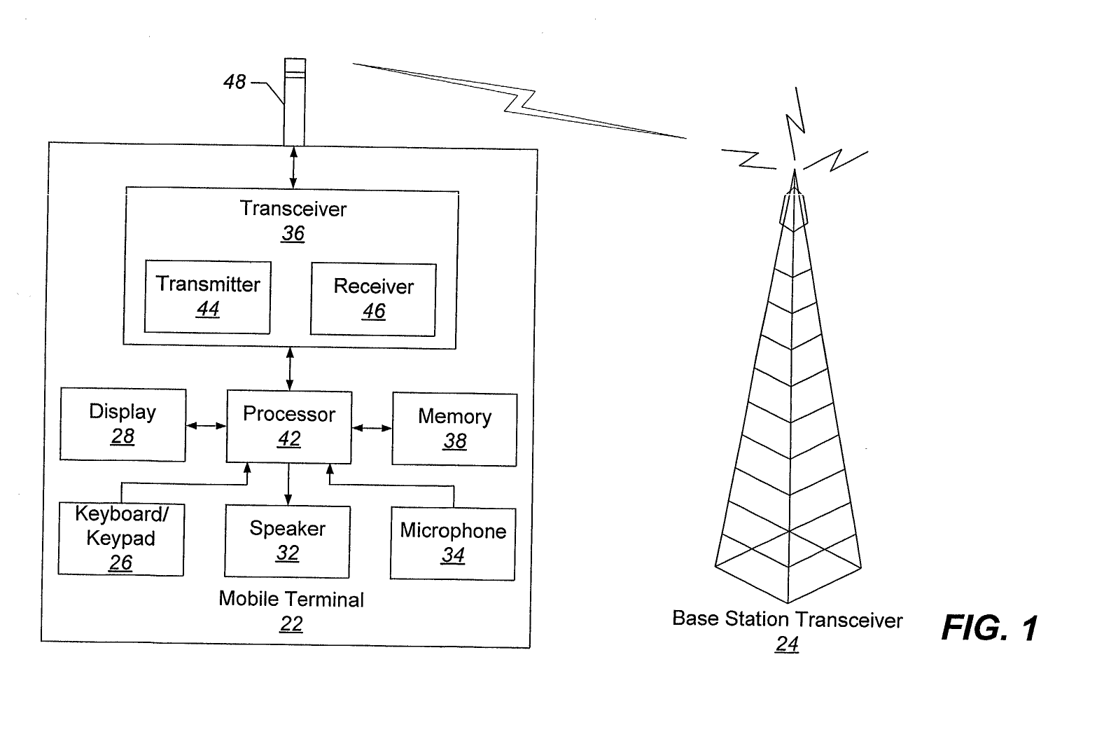

Referring now to FIG. 1, an exemplary radiotelephone communication system, in accordance with embodiments of the present invention, includes a mobile terminal 22 and a base station transceiver 24. The mobile terminal 22 includes a keyboard/keypad 26, a display 28, a speaker 32, a microphone 34, a transceiver 36, and a memory 38 that communicate with a processor 42. The transceiver 36 typically comprises a transmitter circuit 44 and a receiver circuit 46, which respectively transmit outgoing radio frequency signals to the base station transceiver 24 and receive incoming radio frequency signals from the base station transceiver 24 via an antenna 48. The radio frequency signals transmitted between the mobile terminal 22 and the base station transceiver 24 may comprise both traffic and control signals (e.g., paging signals/messages for incoming calls), which are used to establish and maintain communication with another party or destination.

The foregoing components of the mobile terminal 22 may be included in many conventional mobile terminals and their functionality is generally known to those skilled in the art. It should be further understood, that, as used herein, the term “mobile terminal” may include a cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

The base station transceiver 24 contains the radio transceivers that support an individual cell in a cellular network and communicate with the mobile terminal 22 and other mobile terminals in the cell using a radio-link protocol. Although only one base station transceiver 24 is shown, it will be understood that many base station transceivers may be connected through, for example, a mobile switching center and other devices to define a wireless communication network.

It will be understood that although the present invention may be embodied in communication apparatus, such as the mobile terminal 22 and/or the base station transceiver 24, the present invention is not limited to such apparatus and/or systems. For example, the present invention may be embodied in such apparatus as data processing systems, modems, and application specific integrated circuits (ASICS). Indeed, the present invention may be embodied in any method, communication apparatus, and/or computer program product that facilitates detection of an information field in a signal by averaging symbol values across multiple time slot intervals.

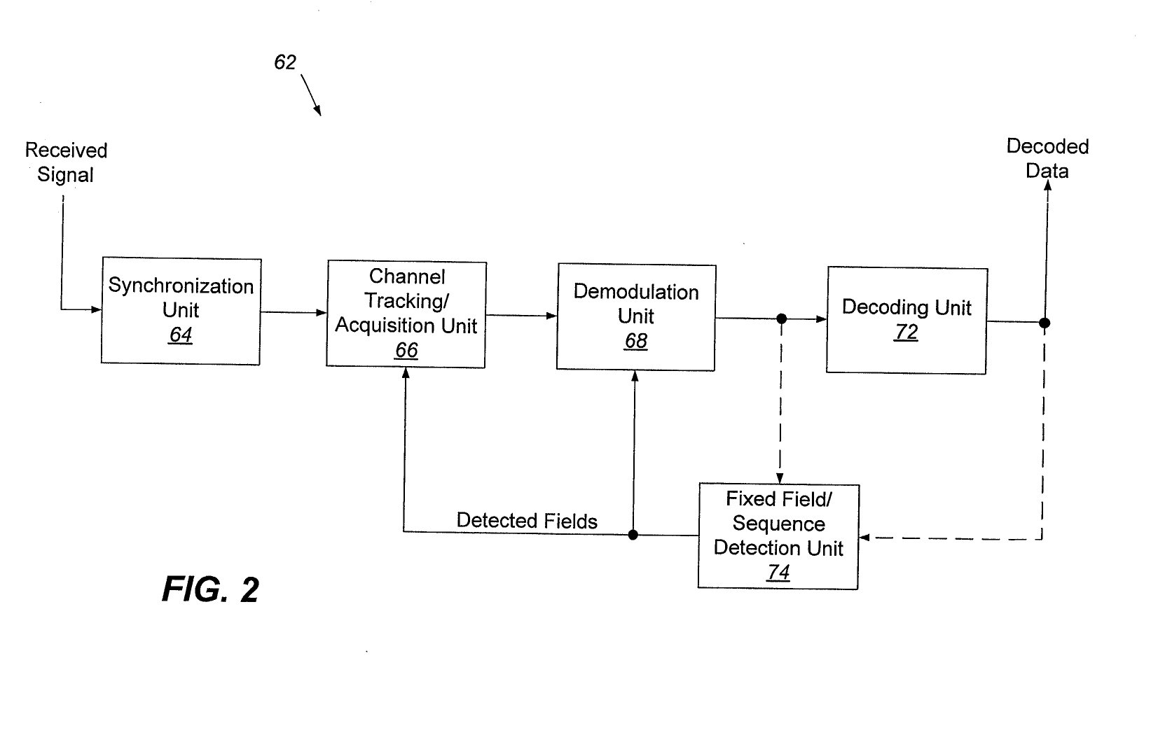

Referring now to FIG. 2, a receiver 62 is shown for detecting an information field in a signal by averaging symbol values across multiple time slot intervals, in accordance with embodiments of the present invention. The receiver includes a synchronization unit 64, a channel tracking/acquisition unit 66, a demodulation unit 68, a decoding unit 72, and a fixed field/sequence detection unit 74, which are configured as shown.

The synchronization unit 64 may be configured to synchronize the incoming received signal with an internal clock used by the receiver 62 and/or to align the incoming received signal with frame and/or time slot boundaries. The channel tracking/acquisition unit 66 may be configured, for example, as an adaptive digital filter to acquire an estimate of the transfer function of the received, signal's communication channel and to update that channel estimate periodically as the received signal's communication channel changes.

The demodulation unit 68 may be configured to extract from the received signal one or more information bearing symbols. These symbols are provided to the decoding unit 72, which may be configured to decode the symbols based on decision criteria and/or error correction decoding protocol(s) to extract information contained in the symbols to provide estimates of received data. Note that a symbol may contain binary information and, therefore, may be embodied as a single bit. It should be understood, however, that a symbol may be used to embody information comprising multiple bits through various encoding and/or modulation techniques.

The fixed field/sequence or information detection unit 74, in various embodiments of the present invention, is configured to locate fields and/or sequences of symbols in the received signal that may not be known a priori. As shown in FIG. 2, the fixed field/sequence detection unit 74 may locate fields and/or sequences of symbols based on the symbols output from the demodulation unit 68 and/or based on the decoded data output from the decoding unit 72. In general, these fields and/or sequences of symbols may be characterized as fixed information that is highly reliable and may be embodied, for example, as synchronization (sync) sequences used for training, codes, such s a coded digital verification color code (CDVCC) used by receivers to identify a desired signal, and/or pilot bits, which may be received periodically and may be used to update timing estimates, channel estimates, and/or symbol demodulation.

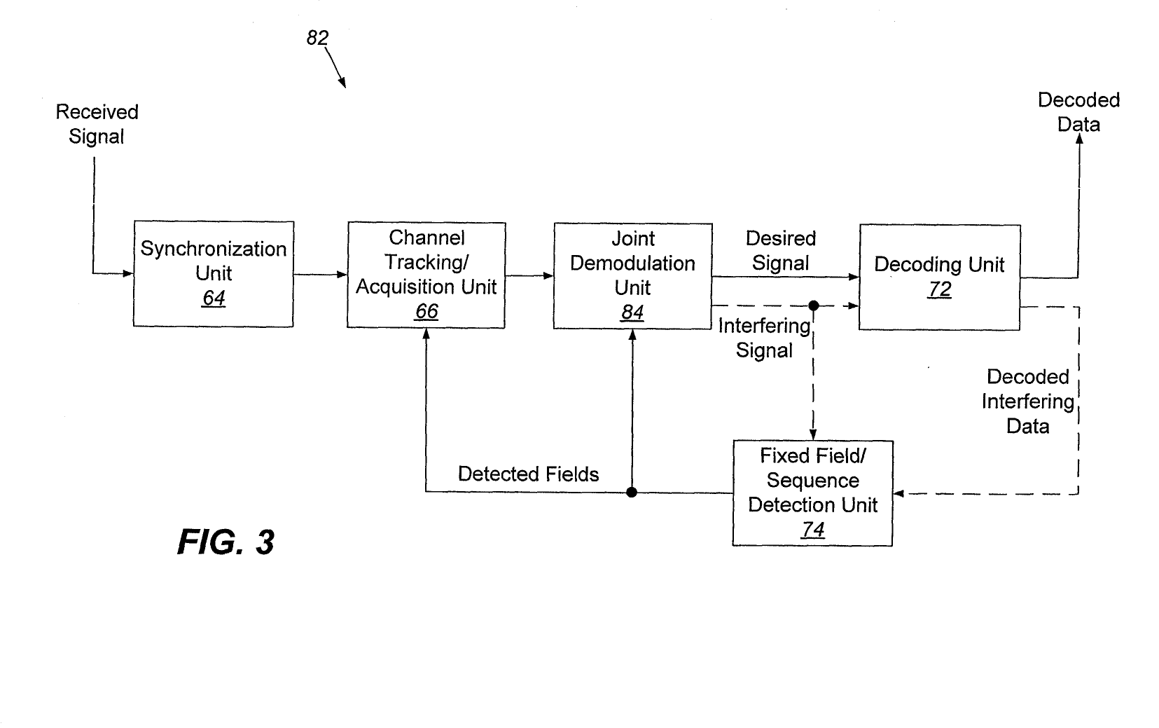

Referring now to FIG. 3, a receiver 82 is shown for detecting an information field in a signal by averaging symbol values across multiple time slot intervals, in accordance with other embodiments of the present invention. The receiver 82 is substantially similar to the receiver 62 shown in FIG. 2 with the exception that a joint demodulation unit 84 replaces the demodulation unit 68. Joint demodulation may be used to detect two or more signals that are received over a common channel. For example, joint demodulation may be used to detect a desired signal from a received signal that includes an interfering signal as well. In joint demodulation, the desired signal and the interfering signal are typically jointly demodulated based on information concerning the desired signal and the interfering signal, so as to obtain a better estimate of the desired signal.

Two-user joint demodulation for ANSI 136 TDMA mobile terminals has been proposed for cancellation of a dominant interfering signal under the assumptions of a flat, slow fading downlink channel environment. By subtracting off the interfering signal, the desired signal's bit error rate may be improved. This occurs where the channel and symbol data corresponding to the interfering signal are not correlated with the desired signal, thereby allowing separation of the two signals. Joint demodulation may, therefore, rely upon the ability to generate channel estimates and perform symbol detection for both the desired signal and the interfering signal. As shown in FIG. 3, the fixed field/sequence detection unit 74 may be configured to locate fields and/or sequences of symbols in the interfering signal and/or the decoded interfering data that are, typically, unknown. The fixed field/sequence detection unit 74 may feed back this information to the channel tracking/acquisition unit 66 and the joint demodulation unit 84 to improve channel estimation and symbol detection for the interfering signal. Detection of the desired signal may be improved, therefore, due to improved detection and cancellation of the interfering signal.

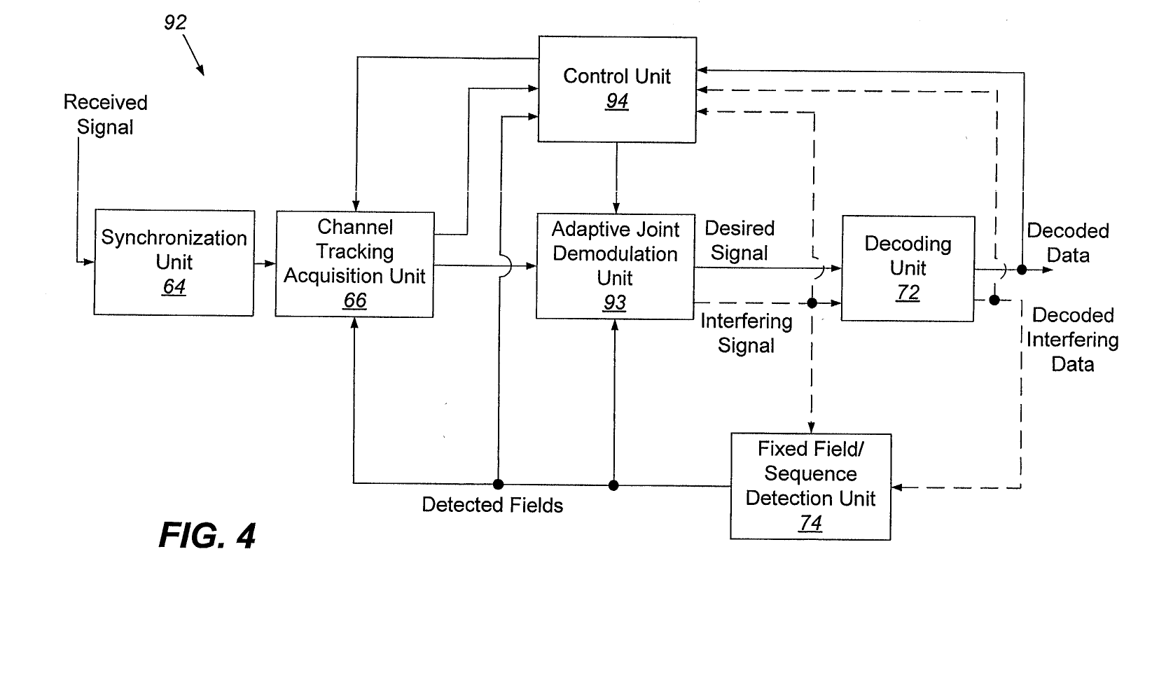

Referring now to FIG. 4, a receiver 92 is shown for detecting an information field in a signal by averaging symbol values across multiple time slot intervals, in accordance with further embodiments of the present invention. The receiver 92 is substantially similar to the receiver 82 shown in FIG. 3, but includes an adaptive joint demodulation unit 93 and a control unit 94 that are connected as shown.

The control unit 94 may be configured to control operation of the adaptive joint demodulation unit 93 to perform either single-user conventional demodulation or two-user joint demodulation based on, for example, the following factors: 1) the presence or absence of a single, dominant interfering signal; 2) the level of dispersion in the desired signal's channel; 3) the speed of a mobile terminal as represented by a Doppler spread value of the desired signal; and 4) the existence of minimal or no signal interference. Selective adaptation of a radio receiver to perform either single-user demodulation or two-user joint demodulation based on the foregoing factors is discussed in detail in U.S. patent application Ser. No. 09/660,050, entitled “Apparatus for and Method of Adapting a Radio Receiver Using Control Functions,” filed Sep. 12, 2000, which is hereby incorporated herein by reference in its entirety.

In accordance with the present invention, the fixed field/sequence detection unit 74 feeds back located fields and/or sequences of symbols in the interfering signal and/or the decoded interfering data to the control unit 94. The information that is fed back from the fixed field/sequence detection unit 74 to the control unit 94 may be considered, along with one or more of the four factors discussed above, in determining whether to perform conventional demodulation or joint demodulation. For example, detection of a fixed field and/or sequence in the interfering signal and/or the decoded interfering data may be indicative of the presence of a single, dominant interfering signal, which typically favors use of joint demodulation.

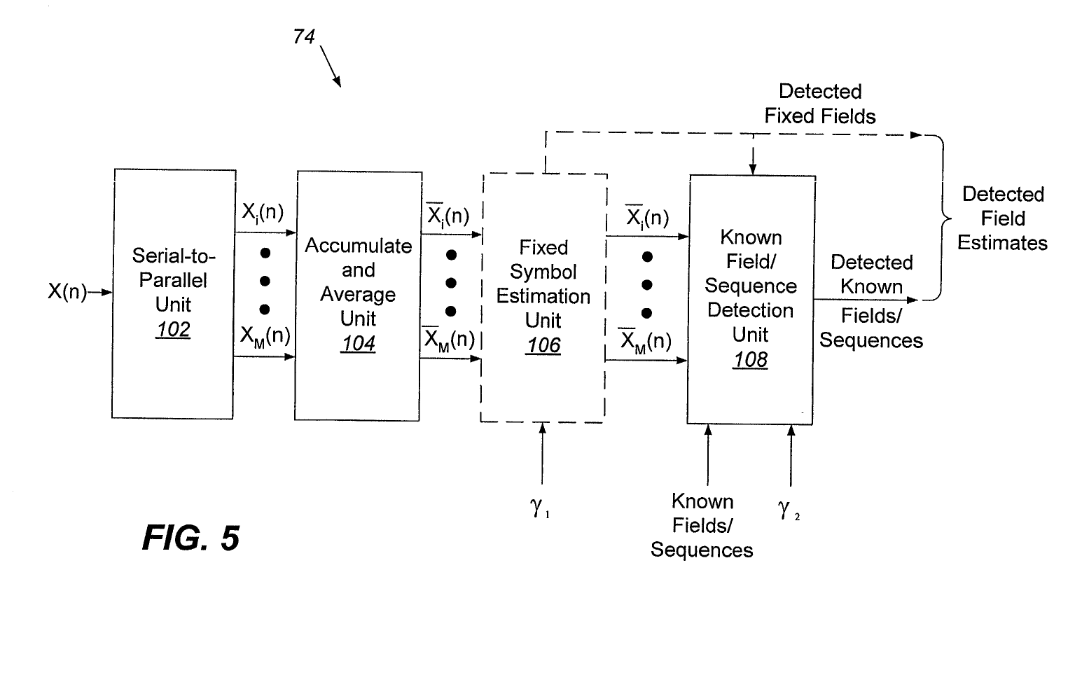

Referring now to FIG. 5, the fixed field/sequence detection unit 74 is further illustrated in accordance with embodiments of the present invention. The fixed field/sequence detect on unit 74 includes a serial to parallel unit 102 that receives an incoming symbol stream x(n) during a time slot n and converts this incoming symbol stream into a parallel stream of M symbols xᵢ(n), i=1 through M. These symbols may be, for example, individual bits received in a bit stream. The symbol streams may be individual bits output from a detector or decoder (e.g., decoding unit 72), and may consist of either hard or soft detected values. Other examples of these symbol streams may be coherently or differentially detected modulation symbols, which may also take either hard or soft values. The symbol streams xᵢ(n) through X_{M}(n) are provided as inputs to an accumulate and average unit 104, which accumulates the respective symbol streams over multiple time slot intervals to obtain accumulation values aᵢ(n), i=1 through M. These accumulation values are used to compute average symbol values \overline{x}ᵢ(n), i=1 through M. The average symbol values for the respective symbol positions, \overline{x}ᵢ(n), i=1 through M, may optionally be provided to a fixed symbol estimation unit 106, which is responsive to a symbol threshold value γ₁ and may determine whether one or more of the M symbol positions contains a fixed symbol (i.e., the symbol value contained in that position remains substantially constant over time). Estimated fixed symbols are used as the detected fixed field estimates and are output together with the detected known field/sequence estimates to provide the detected field output from the fixed field/sequence detection unit 74.

The average symbol values for the respective symbol positions, \overline{x}ᵢ(n), i=1 through M, as shown in FIG. 5, are provided to a known field/sequence detection unit 108, which is responsive to a library of one or more known fields/sequences that may be contained in the incoming symbol stream x(n), a correlation threshold value γ₂, which may be used in correlating the average symbol values for the respective symbol positions, \overline{x}ᵢ(n), with the library of known fields/sequences, and, optionally, a signal from the fixed symbol estimation unit 106 identifying fixed symbols.

The functionality of any or all of the units comprising the receiver embodiments of FIGS. 2-4 and the fixed field/sequence detection unit embodiments of FIG. 5 may be implemented using discrete hardware components, a single application specific integrated circuit (ASIC), a programmed digital signal processor or microcontroller or combinations thereof. Moreover, FIGS. 2-5 illustrate exemplary architectures that may be used for detecting an information field in a signal by averaging symbol values across multiple time slot intervals in accordance with embodiments of the present invention. It will be understood that the present invention is not limited to these configurations, but is intended to encompass any configuration capable of carrying out the operations described herein.

The present invention is described hereinafter with reference to flowchart and/or block diagram illustrations of methods, apparatus, and computer program products in accordance with exemplary embodiments of the invention. It will be understood that each block of the flowchart and/or block diagram illustrations, and combinations of blocks in the flowchart and/or block diagram illustrations, may be implemented by computer program instructions. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

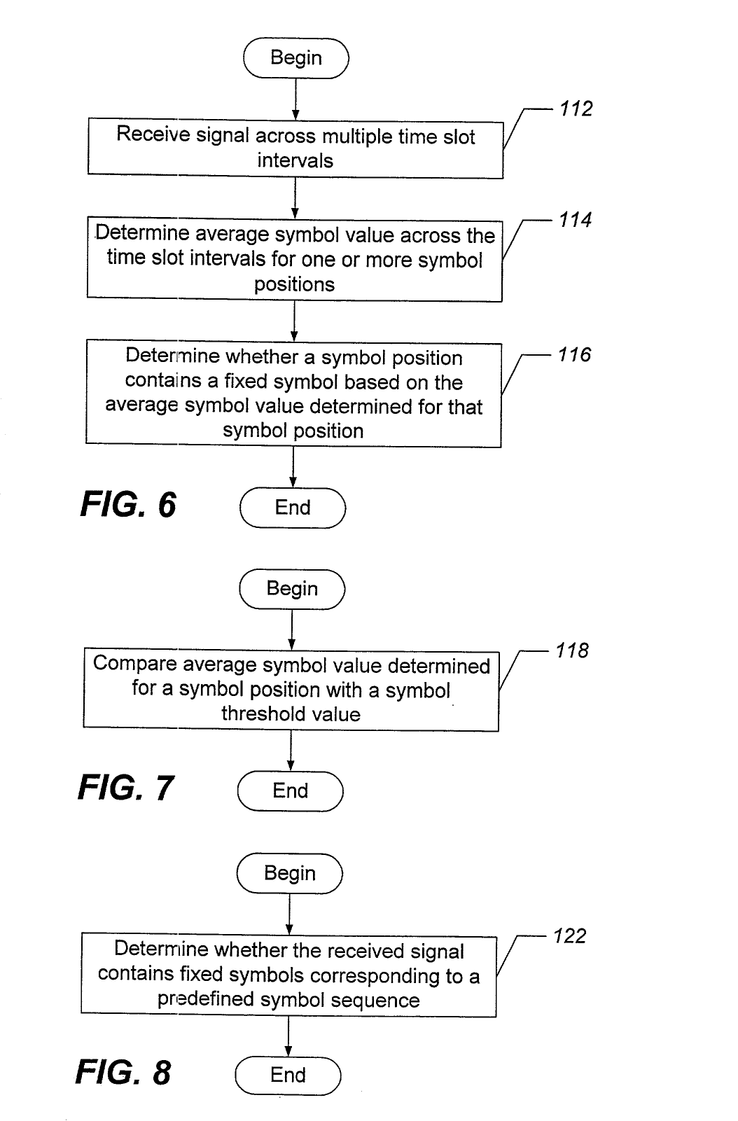

With reference to the flowcharts of FIGS. 6-11 and the block diagrams of FIGS. 2-5, exemplary operations of methods, communication apparatus, and computer program products for detecting an information field in a signal by averaging symbol values across multiple time slot intervals, in accordance with embodiments of the present invention, will now be further described. Referring first to FIG. 6, operations begin at block 112 where the fixed field/sequence detection unit 74 receives a signal from a demodulation unit and/or decoding unit across multiple time slot intervals. In accordance with embodiments of the present invention, the signal may be a desired signal from the single user conventional demodulation unit 68, an interfering signal from the two-user joint demodulation unit 84, an interfering signal from the adaptive joint demodulation unit 93, decoded data from the decoding unit 72, and/or decoded interfering data from the decoding unit 72.

At block 114, the accumulate and average unit 104 of the fixed field/sequence detection unit 74 determines an average symbol value across the time slot intervals for one or more of the M symbol positions in the time slot. In accordance with embodiments of the present invention, the average symbol values \overline{x}ᵢ(n) and the accumulation values aᵢ(n), i=1 through M, may be determined in various ways. Four exemplary averaging and accumulation algorithms that may be used in embodiments of the present invention are as follows:

Sample Average:

$$\begin{matrix}\begin{matrix}{\overline{x}}_{i} ( n ) = \frac{1}{n} {\sum }_{k = 0}^{n} {x}_{i} ( n ) , \\ = \frac{1}{n} {a}_{i} ( n ) ,\end{matrix} & ( 1 ) \\ {a}_{i} ( n ) = {a}_{i} ( n - 1 ) + {x}_{i} ( n ) & ( 2 )\end{matrix}$$

aᵢ(n)=aᵢ(n−1)+xᵢ(n) (2)

Moving Average:

$$\begin{matrix}\begin{matrix}{\overline{x}}_{i} ( n ) = \frac{1}{W - 1} {\sum }_{k = n - W + 1}^{n} {x}_{i} ( n ) , \\ = \frac{1}{W - 1} {a}_{i} ( n ) ,\end{matrix} & ( 3 ) \\ {a}_{i} ( n ) = {a}_{i } ( n - 1 ) + {x}_{i} ( n ) - {x}_{i} ( n - W ) & ( 4 )\end{matrix}$$

aᵢ(n)=aᵢ(n−1)+xᵢ(n)−xᵢ(n−W) (4)

where W is a number that represents how many previous time slot intervals to use in computing the average.

Exponentially Weighted Average:

$$\begin{matrix}\begin{matrix}{\overline{x}}_{i} ( n ) = ( 1 - λ ) {\sum }_{k = 0}^{n} {λ}^{n - k} {x}_{i} ( k ) , \\ = {a}_{i} ( n ) ,\end{matrix} & ( 5 ) \\ {a}_{i} ( n ) = λ {a}_{i} ( n - 1 ) + ( 1 - λ ) {x}_{i} ( n ) & ( 6 )\end{matrix}$$

aᵢ(n)=λaᵢ(n−1)+(1−λ)xᵢ(n) (6)

where λ is a number between 0 and 1 that is used to adjust the weight given to symbol values based on when the symbol was received.

Exponentially Weighted Moving Average:

$$\begin{matrix}\begin{matrix}{\overline{x}}_{i} ( n ) = \frac{1 - λ}{1 - {λ}^{W}} {\sum }_{k = n - W + 1}^{n} {λ}^{n - k} {x}_{i} ( n ) , \\ = {a}_{i} ( n ) ,\end{matrix} & ( 7 ) \\ {a}_{i} ( n ) = λ {a}_{i} ( n - 1 ) + \frac{1 - λ}{1 - {λ}^{W}} [ {x}_{i} ( n ) - {λ}^{W} {x}_{i} ( n - W ) ] & ( 8 )\end{matrix}$$

The sample average and exponentially weighted average algorithms may be preferred if memory is scarce because symbol values need not be stored to allow computation of an average based on a particular window in time. By contrast, if memory is readily available, then either the moving average or exponentially weighted moving average algorithms may be preferred because a window W may be set to identify a particular set of time slots in which to accumulate and average symbol values. Both the exponentially weighted average and the exponentially weighted moving average algorithms may be preferred when it is desirable to assign more weight to recently detected symbol values than previously detected symbol values. Based on simulations for an ANSI 136 TDMA communication system a window length W of 10 and a value for λ of 0.7 may be used in embodiments of the present invention.

It will be further understood that, in accordance with the present invention, assigning an “average” symbol value for a particular symbol position may involve accumulating symbol values at that symbol position for a predetermined number of time slots and then comparing the accumulated value with a threshold selected based on the number of symbol values accumulated. An average for the symbol value may be determined based on the comparison of the accumulated value with the threshold.

Returning to FIG. 6, at block 116, the fixed symbol estimation unit 106 determines whether a symbol position i contains a fixed symbol based on the average symbol value \overline{x}ᵢ(n) determined for that position. The present invention recognizes that a symbol that does not vary significantly between time slots is likely fixed and may correspond to a fixed field or sequence in the received signal. In accordance with various embodiments of the present invention, hard or soft information values may be used to represent the received symbol values xᵢ(n), i=1 through M.

For purposes of illustration assume that the symbols xᵢ(n), i=1 through M comprising the signal are embodied as binary bits. Hard information values of −1 and 1 may, therefore, be used to represent the symbols xᵢ(n) taking logic values 0 and 1, respectively. Alternatively, soft information values may be used that are indicative of the likelihood that a particular symbol xᵢ(n) is a −1 or 1. For example, a symbol xᵢ(n) may assume a soft information value ranging from −αto α, where α represents a hard detection of 1, −α represents a hard detection of −1, and 0 represents an equal likelihood of a −1 or 1.

Thus, referring now to FIG. 7, the fixed symbol estimation unit 106 determines whether a symbol position contains a fixed symbol, in accordance with particular embodiments of the present invention, by comparing the average symbol value xᵢ(n) determined for that position with the symbol threshold value γ₁ at block 118. In the context of the symbols xᵢ(n) being binary bits represented as soft information values ranging from −α to α, if the bit position i does not contain a fixed bit, then the average symbol value \overline{x}ᵢ(n) would be expected to be approximately zero at time slot n (assuming an equal number of logic values zero and one across the averaging sample). Therefore, the fixed symbol estimation unit 106 may determine that a bit position i contains a fixed bit if |\overline{x}ᵢ(n)|>γ₁. The output value \overline{x}ᵢ(n) can be the average itself, which is a soft value. Alternatively, \overline{x}ᵢ(n) can be quantized to hard values −1 or 1, which represent the detected value of the fixed bit, or to 0, which represents a non-fixed bit.

In the case that the symbols represent coherent or differentially detected modulation symbols, they will take complex values. For example, for coherent QPSK modulation, the complex symbols may take the values {s₀=1+i0, s₁=0+i1, s₂=−1+i0, s₃=0−i1}. The symbol values can be averaged as discussed hereinabove, but the detection of the fixed symbol uses a modified threshold detection. A fixed symbol corresponding to symbol s₀ is detected using |\overline{x}ᵢ(n)−s₀|<γ₁. Here, γ₁ is set so that only one of the possible symbols can be declared fixed, and each possible symbol must be checked against the threshold. Again, \overline{x}ᵢ(n) can be quantized to hard values or to zero when no fixed symbol is detected.

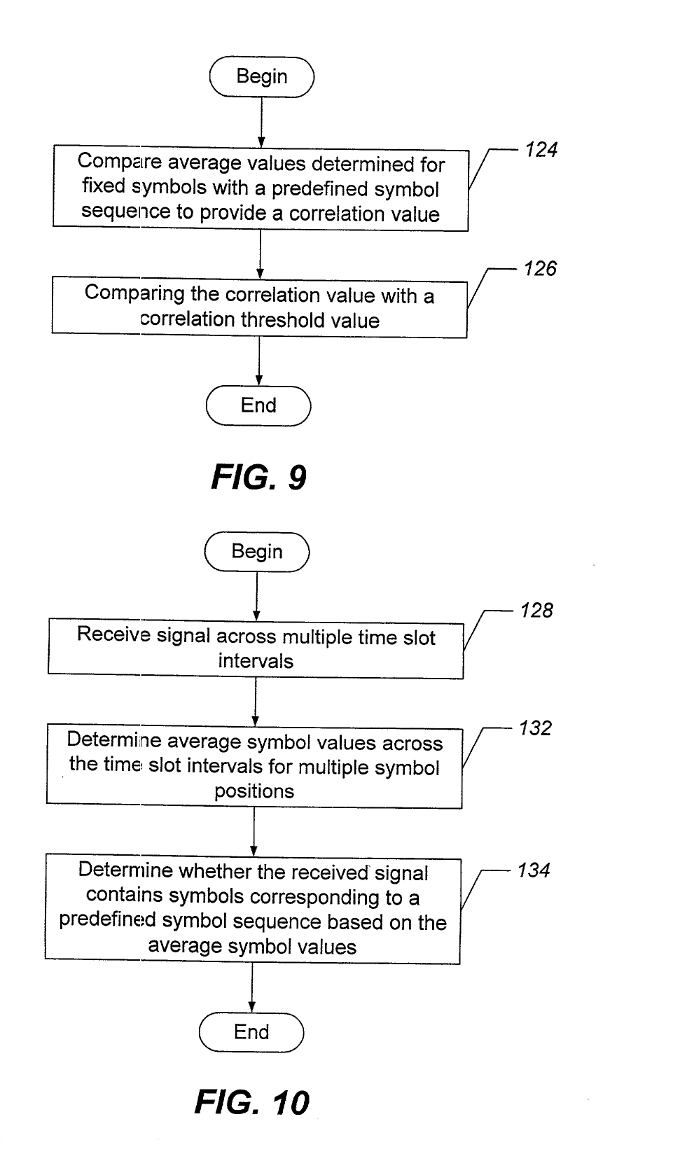

Referring now to FIG. 8, the known field/sequence detection unit 108 may determine whether the received signal contains fixed symbols that correspond to a predefined symbol sequence, such as a sync sequence, CDVCC code, pilot bit pattern, etc., at block 122. In particular embodiments of the present invention illustrated in FIG. 9, the known field/sequence detection unit 108 may determine whether the received signal contains fixed symbols that correspond to a predefined symbol sequence by comparing the average values determined for fixed symbols with one or more predefined symbol sequences to provide a correlation value at block 124. For example, the average symbol values may be viewed as a sequence \overline{x}(n)−[\overline{x}ᵢ(n),\overline{x}₂(n), . . . , x_{M}(n)]. The known field/sequence detection unit 108 may determine a correlation value y(n) between the sequence \overline{x}(n) and a known field or sequence f, which is represented as follows: y(n)=corr(\overline{x}(n),f). The correlation value may be viewed as a set of correlation values yᵢ(n), i=1 through M between the known field or sequence f and the average symbol values \overline{x}ᵢ(n), i=1 through M. Thus, the known field/sequence detection unit 108 may compare the correlation values yᵢ(n), i=1 through M with the correlation threshold value γ₂ at block 126 to determine whether the received signal contains fixed symbols corresponding to the predefined symbol sequence f. The known field/sequence detection unit 108 may determine that if |yᵢ(n)|>γ₂, then the known field/sequence f is detected at symbol position i during time slot n.

Advantageously, if the fixed symbol estimation unit 106 is used to determine which one(s) of the M symbol positions contain fixed symbols as discussed hereinabove, then the correlation values yi (n) need be computed only at those symbol positions that have been determined to have fixed symbol values. This may also allow the known field/sequence detection unit 108 to select only those known fields/sequences that have the same or greater length than the sequence length of the fixed symbols as candidates for correlation.

In accordance with further embodiments of the present invention, illustrated in FIG. 10, the fixed symbol estimation unit 106 need not be used to determine which symbol positions i contain fixed symbols. Operations begin at block 128 where the fixed field/sequence detection unit 74 receives a signal from a demodulation unit and/or a decoding unit across multiple time slot intervals. At block 132, the accumulate and average unit 104 of the fixed field/sequence detection unit 74 determines an average symbol value across the time slot intervals for one or more of the M symbol positions in the time slot. The operations of blocks 128 and 132 are substantially similar to the operations of blocks 112 and 114 of FIG. 6 discussed hereinabove and need not be described further. At block 134, the known field/sequence detection unit 108 determines whether the received signal contains symbols corresponding to a predefined symbol sequence, such as a sync sequence, CDVCC code, pilot bit pattern, etc., based on the average symbol values.

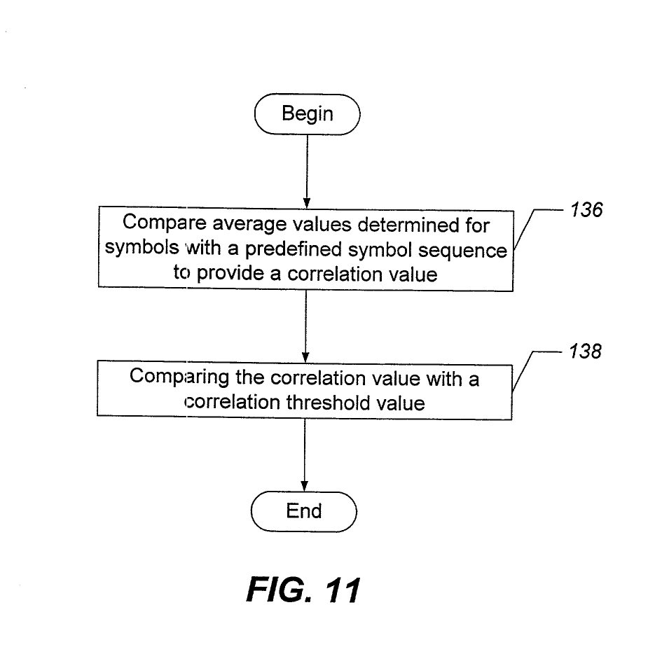

In particular embodiments of the present invention illustrated in FIG. 11, the known field/sequence detection unit 108 determines whether the received signal contains symbols corresponding to a predefined symbol sequence by comparing the average values determined for fixed symbols with one or more predefined symbol sequences to provide a correlation value at block 136. Thus, as discussed above with respect to block 124 of FIG. 9, a correlation value y(n) may be computed between the sequence \overline{x}(n) and a known field or sequence f. Recall that the correlation value may be viewed as a sit of correlation values yᵢ(n), i=1 through M between the known field or sequence f and the average symbol values \overline{x}ᵢ(n), i=1 through M. In contrast with the embodiments discussed above with respect to FIG. 9, which are based on determining which symbol positions i contain fixed symbols through use of the fixed symbol estimation unit 106, the correlation values yᵢ(n), i=1 through M are computed at all symbol positions.

At block 138, the known field/sequence detection unit 108 may compare the correlation values yᵢ(n), i=1 through M with the correlation threshold value γ₂ to determine whether the received signal contains fixed symbols corresponding to the predefined symbol sequence f. For example, the known field/sequence detection unit 108 may determine that if |yᵢ(n)|>γ₂, then the known field/sequence f is detected at symbol position i during time slot n. Because the known field/sequence detection unit 108 need not be provided with information regarding which symbol positions contain fixed symbols, correlation values yᵢ(n) are computed at every symbol position. Moreover, the known field/sequence detection unit 108 may not be able to limit the number of potential known fields/sequences that are candidates for correlation where the fixed symbol estimation unit 106 is not used to provide an estimate of which symbol positions contain fixed symbols.

In ANSI 136 TDMA communication systems, for example, a dominant interfering signal may be generated by a neighboring communication channel. In this case, a receiver may possess some knowledge concerning likely fixed fields/sequences (e.g., likely synchronization sequences) that may be used by the neighboring communication channel. In this case, in accordance with particular embodiments of the present invention, the number of time slot intervals over which symbol values are averaged may be reduced to, for example, three time slot intervals or less, and the known field/sequence detection unit 108 may determine whether the received signal contains symbols corresponding to the likely fixed field/sequence as described hereinabove.

The flowcharts of FIGS. 6-11 show the architecture, functionality, and operation of exemplary embodiments of methods, communication apparatus, and computer program products for detecting an information field in a signal by averaging symbol values across multiple time slot intervals. In this regard, each block may represent a module, segment, or portion of code, which comprises one or more executable instructions for implementing the specified logical function(s). It should also be noted that in some embodiments, the functions noted in the blocks may occur out of the order noted in FIGS. 6-11. For example, two blocks shown in succession in FIGS. 6-11 may be executed substantially concurrently or the blocks may sometimes be executed in the reverse order, depending upon the functionality involved.

In accordance with the present invention, after detecting fixed symbol fields, this information may be used for improving channel estimation and acquisition in subsequent time slots. In the case of joint demodulation systems, if a fixed field/sequence is detected in an interfering signal, then this information may be used to obtain improved channel estimates and timing of the interfering signal by modulating the fixed field/sequence and then using well-known techniques, such as correlation and least-square channel estimation. Indirectly, improved acquisition, demodulation, and detection of the interfering signal may improve acquisition, demodulation, and detection of the desired signal because the receiver may be better able to cancel the interfering signal. Based on simulation results for an ANSI 136 TDMA communication system, embodiments of the present invention in which a fixed field/sequence is detected in an interfering signal by averaging symbol values across multiple time slot values may improve detection of a desired signal in a joint demodulation system when the power ratio of the desired signal to the interfering signal (C/I) is in a range of approximately 10 dB to approximately 25 dB and a power ratio of the desired signal to a noise signal (C/N) is in a range of approximately 23 dB to approximately 33 dB. The noise signal may include thermal noise and/or interfering signals other than a single, dominant interfering signal.

During demodulation, the detected fixed field/sequence in an interfering signal may be used for retraining, similar to a process that may be used in conventional equalization for retraining over the CDVCC field. For example, the fixed field/sequence in the interfering signal may be demodulated to ensure that it may be detected reliably. If the fixed field/sequence in the interfering signal is reliably detected, then demodulation may be restarted at the beginning of the fixed field/sequence and training of the demodulator for the interfering signal's channel may occur over the fixed field/sequence. If multiple fixed fields/sequences are found in an interfering signal and they are spaced adequately, then these fields/sequences may be treated as pilot symbols to assist in tracking changes in the quality of the interfering signal's channel.

From the foregoing, it can readily be seen that, in accordance with the present invention, improved performance may be obtained for systems that use joint demodulation by improving the acquisition performance and channel estimation for both a desired signal and an interfering signal and the estimation of the relative timing delay for the interfering signal by making use of an otherwise unknown fixed field/sequence (i.e., fixed information) in an interfering signal. Even if the detected fixed field/sequence in the interfering signal is not used to replace a conventional channel acquisition process for the interfering signal, the detected fixed field/sequence may nevertheless be used to reduce the complexity of the channel acquisition process by providing better initial channel and/or delay estimates for the interfering signal.

In addition, the present invention may be used in single user, conventional demodulation systems to detect a fixed field/sequence, which may not be known by the receiver. For example, a receiver may use the present invention to detect a CDVCC code on a control channel. Once detected, the receiver may use the CDVCC code to demodulate a traffic channel.

It should be noted that many variations and modifications can be made to the preferred embodiments described above without substantially departing from the principles of the present invention. All such variations and modifications are intended to be included herein within the scope of the present invention, as set forth in the following claims.

We claim:

1. A method of processing a signal, comprising:
receiving the signal across a plurality of time slot intervals, respective ones of the plurality of time slot intervals having a plurality of symbol positions associated therewith to provide a sequence of symbols associated with the received signal;
determining an average value across the plurality of time slot intervals for a respective one of the plurality of symbol positions; and
determining whether the respective one of the plurality of symbol positions contains a fixed symbol based on the average value determined for the respective one of the plurality of symbol positions.

2. The method as recited in claim 1, wherein determining whether the respective one of the plurality of symbol positions contains a fixed symbol based on the average value determined for the respective one of the plurality of symbol positions comprises:
comparing the average value determined for the respective one of the plurality of symbol positions with a symbol threshold value.

3. The method as recited in claim 1, wherein determining an average value across the plurality of time slot intervals for the respective one of the plurality of symbol positions comprises:
determining average values across the plurality of time slot intervals for respective ones of the plurality of symbol positions;
wherein determining whether the respective one of the plurality of symbol positions contains a fixed symbol based on the average value determined for the respective one of the plurality of symbol positions comprises:
determining whether the respective ones of the plurality of symbol positions contain fixed symbols based on the average values determined for the respective ones of the plurality of symbol positions; and
wherein the method further comprises:
determining whether the received signal contains fixed symbols corresponding to a predefined symbol sequence.

4. The method as recited in claim 3, wherein determining whether the respective ones of the plurality of symbol positions contain fixed symbols based on the average values determined for the respective ones of the plurality of symbol positions comprises:
comparing the average values determined for the respective ones of the plurality of symbol positions with a symbol threshold value.

5. The method as recited in claim 3, wherein determining whether the received signal contains fixed symbols corresponding to the predefined symbol sequence comprises:
comparing the average values determined for the fixed symbols with the predefined symbol sequence to provide a correlation value; and
comparing the correlation value with a correlation threshold value.

6. The method as recited in claim 1, wherein the average value is determined using an algorithm selected from the group consisting of a sample average algorithm, a moving average algorithm, an exponentially weighted average algorithm, and an exponentially weighted moving average algorithm.

7. The method as recited in claim 1, further comprising:
associating each of the received symbols with a soft information value.

8. The method as recited in claim 7, wherein determining an average value across the plurality of time slot intervals for the respective one of the plurality of symbol positions comprises:
determining an average soft information value across the plurality of time slot intervals for the respective one of the plurality of symbol positions.

9. The method as recited in claim 8, wherein the average soft information value is determined using an algorithm selected from the group consisting of a sample average algorithm, a moving average algorithm, an exponentially weighted average algorithm, and an exponentially weighted moving average algorithm.

10. The method as recited in claim 8, wherein determining whether the respective one of the plurality of symbol positions contains a fixed symbol based on the average value determined for the respective one of the plurality of symbol positions comprises:
determining whether the respective one of the plurality of symbol positions contains a fixed symbol based on the average soft information value determined for the respective one of the plurality of symbol positions.

11. The method as recited in claim 10, wherein determining whether the respective one of the plurality of symbol positions contains a fixed symbol based on the average soft information value determined for the respective one of the plurality of symbol positions comprises:
comparing the average soft information value determined for the respective one of the plurality of symbol positions with a symbol threshold value.

12. The method as recited in claim 10, wherein determining the average soft information value across the plurality of time slot intervals for the respective one of the plurality of symbol positions comprises:
determining average soft information values across the plurality of time slot intervals for respective ones of the plurality of symbol positions;
wherein determining whether the respective one of the plurality of symbol positions contains a fixed symbol based on the average soft information value determined for the respective one of the plurality of symbol positions comprises:
determining whether the respective ones of the plurality of symbol positions contain fixed symbol based on the average soft information values determined for the respective ones of the plurality of symbol positions; and
wherein the method further comprises:
determining whether the received signal contains fixed symbols corresponding to a predefined symbol sequence.

13. The method as recited in claim 12, wherein determining whether the respective ones of the plurality of symbol positions contain fixed symbols based on the average soft information values determined for the respective ones of the plurality of symbol positions comprises:
comparing the average soft information values determined for the respective ones of the plurality of symbol positions with a symbol threshold value.

14. The method as recited in claim 12, wherein determining whether the received signal contains fixed symbols corresponding to a predefined symbol sequence comprises:
comparing the average soft information values determined for the fixed symbols with the predefined symbol sequence to provide a correlation value; and
comparing the correlation value with a correlation threshold value.

15. The method as recited in claim 1, wherein receiving the signal across the plurality of time slot intervals comprises:
demodulating the signal to generate the sequence of symbols.

16. The method as recited in claim 1, wherein receiving the signal across the plurality of time slot intervals comprises:
decoding the sequence of symbols to generate a sequence of decoded symbols associated with the received signal;
wherein determining the average value across the plurality of time slot intervals for the respective one of the plurality of symbol positions comprises:
determining an average decoded symbol value across the plurality of time slot intervals for the respective one of the plurality of symbol positions; and
wherein determining whether the respective one of the plurality of symbol positions contains the fixed symbol based on the average value determined for the respective one of the plurality of symbol positions comprises:
determining whether the respective one of the plurality of symbol positions contains the fixed symbol based on the average decoded symbol value determined for the respective one of the plurality of symbol positions.

17. A method of processing a signal, comprising:
receiving the signal across a plurality of time slot intervals, respective ones of the plurality of time slot intervals having a plurality of symbol positions associated therewith to provide a sequence of symbols associated with the received signal;
determining average values across the plurality of time slot intervals for respective ones of the plurality of symbol positions; and
determining whether the received signal contains symbols corresponding to a predefined symbol sequence based on the average values determined for the respective ones of the plurality of symbol positions.

18. The method as recited in claim 17, wherein determining whether the received signal contains symbols corresponding to the predefined symbol sequence based on the average values determined for respective ones of the plurality of symbol positions comprises:
comparing the average values determined for the respective ones of the plurality of symbol positions with the predefined symbol sequence to provide a correlation value; and
comparing the correlation value with a correlation threshold value.

19. The method as recited in claim 17, further comprising:
determining whether the respective ones of the plurality of symbol positions contain fixed symbols based on the average values determined for the respective ones of the plurality of symbol positions; and
determining whether the received signal contains fixed symbols corresponding to the predefined symbol sequence.

20. The method as recited in claim 19, wherein determining whether the respective ones of the plurality of symbol positions contain fixed symbols based on the average values determined for the respective ones of the plurality of symbol positions comprises:
comparing the average values determined for the respective ones of the plurality of symbol positions with a symbol threshold value.

21. The method as recited in claim 19, wherein determining whether the received signal contains fixed symbols corresponding to the predefined symbol sequence comprises:
comparing the average values determined for the fixed symbols with the predefined symbol sequence to provide a correlation value; and
comparing the correlation value with a correlation threshold value.

22. The method as recited in claim 17, wherein the plurality of time slot intervals is N time slot intervals, wherein N is not greater than three.

23. The method as recited in claim 17, wherein receiving the signal across the plurality of time slot intervals comprises:
demodulating the signal to generate the sequence of symbols.

24. The method as recited in claim 17, wherein receiving the signal across the plurality of time slot intervals comprises:
decoding the sequence of symbols to generate a sequence of decoded symbols associated with the received signal;
wherein determining the average values across the plurality of time slot intervals for the respective ones of the plurality of symbol positions comprises:
determining average decoded symbol values across the plurality of time slot intervals for the respective ones of the plurality of symbol positions; and
wherein determining whether the received signal contains symbols corresponding to the predefined symbol sequence based on the average values determined for the respective ones of the plurality of symbol positions comprises:
determining whether the received signal contains symbols corresponding to the predefined symbol sequence based on the average decoded symbol values determined for the respective ones of the plurality of symbol positions.

25. A method of processing a received signal, which comprises a desired signal and an interference signal, across a plurality of time slot intervals, respective ones of the plurality of time slot intervals having a plurality of symbol positions associated therewith to provide a sequence of symbols associated with the received signal, the method comprising:
determining an average value across the plurality of time slot intervals for a respective one of the plurality of symbol positions; and
determining whether the received signal contains a symbol corresponding to a symbol associated with the interference signal based on the average value determined for the respective one of the plurality of symbol positions.

26. The method as recited in claim 25, wherein determining an average value across the plurality of time slot intervals for the respective one of the plurality of symbol positions comprises:
determining average values across the plurality of time slot intervals for respective ones of the plurality of symbol positions; and
wherein determining whether the received signal contains a symbol corresponding to the symbol associated with the interference signal based on the average value determined for the respective one of the plurality of symbol positions comprises:
determining whether the received signal contains symbols corresponding to a symbol sequence associated with the interference signal based on the average values determined for respective ones of the plurality of symbol positions.

27. The method as recited in claim 26, further comprising:
processing the desired signal based on the determination of whether the received signal contains symbols corresponding to the symbol sequence associated with the interference signal.

28. The method as recited in claim 27, wherein processing the desired signal based on the determination of whether the received signal contains symbols corresponding to the symbol sequence associated with the interference signal comprises:
determining whether to demodulate the received signal using joint demodulation based on the determination of whether the received signal contains symbols corresponding to the symbol sequence associated with the interference signal.

29. The method as recited in claim 28, wherein a ratio of a power of the desired signal to a power of the interference signal is in a range of about 10 dB to about 25 dB.

30. The method as recited in claim 28, wherein the received signal further comprises a noise signal, and wherein a ratio of a power of the desired signal to a power of the noise signal is in a range of about 23 dB to about 33 dB.

31. The method as recited in claim 27, wherein processing the desired signal based on the determination of whether the received signal contains symbols corresponding to the symbol sequence associated with the interference signal comprises:
estimating a channel associated with the interference signal based on the symbol sequence associated with the interference signal if the received signal contains symbols corresponding to the symbol sequence associated with the interference signal.

32. The method as recited in claim 31, wherein processing the desired signal based on the determination of whether the received signal contains symbols corresponding to the symbol sequence associated with the interference signal comprises:
estimating a timing delay between the desired signal and the interference signal based on the symbol sequence associated with the interference signal if the received signal contains symbols corresponding to the symbol sequence associated with the interference signal.

33. The method as recited in claim 26, further comprising:
determining whether the respective ones of the plurality of symbol positions contain fixed symbols based on the average values determined for the respective ones of the plurality of symbol positions; and
determining whether the received signal contains fixed symbols corresponding to the symbol sequence associated with the interference signal.

34 The method as recited in claim 33, wherein determining whether the respective ones of the plurality of symbol positions contain fixed symbols based on the average values determined for the respective ones of the plurality of symbol positions comprises:
comparing the average values determined for the respective ones of the plurality of symbol positions with a symbol threshold value.

35. The method as recited in claim 33, wherein determining whether the received signal contains fixed symbols corresponding to the symbol sequence associated with the interference signal comprises:
comparing the average values determined for the fixed symbols with the symbol sequence associated with the interference signal to provide a correlation value; and
comparing the correlation value with a correlation threshold value.

36. The method as recited in claim 26, wherein the symbol sequence associated with the interference signal is a predefined symbol sequence.

37. A communication apparatus, comprising:
a fixed information detection unit that is responsive to a received sequence of symbols associated with a signal received across a plurality of time slot intervals, the fixed information detection unit comprising:
an averaging unit that generates an average value across the plurality of time slot intervals for a respective one of the plurality of symbol positions responsive to the received signal; and
a fixed symbol estimation unit that generates a fixed symbol control signal that identifies whether the respective one of the plurality of symbol positions contains a fixed symbol responsive to the average value generated for the respective one of the plurality of symbol positions.

38. The communication apparatus as recited in claim 37, wherein the averaging unit generates average values across the plurality of time slot intervals for respective ones of the plurality of symbol positions responsive to the received signal, and wherein the fixed symbol estimation unit generates the fixed symbol control signal that identifies whether respective ones of the plurality of symbol positions contain fixed symbols responsive to the average values generated for the respective ones of the plurality of symbol positions, the communication apparatus further comprising:
a known information detection unit that generates an output signal indicative of whether the received signal contains fixed symbols corresponding to a predefined symbol sequence responsive to the fixed symbol control signal and the average values generated for the identified respective ones of the plurality of symbol positions

39. The communication apparatus as recited in claim 38, further comprising:
a demodulation unit that generates the received sequence of symbols responsive to the received signal and the output signal from the known information detection unit.

40. The communication apparatus as recited in claim 39, wherein the demodulation unit is a joint demodulation unit, the received signal comprises a desired signal and an interfering signal, and the received sequence of symbols are associated with the interfering signal.

41. The communication apparatus as recited in claim 40, wherein the joint demodulation unit is an adaptive joint demodulation unit.

42. The communication apparatus as recited in claim 41, further comprising a control unit that generates a mode control signal responsive to the output signal from the known information detection unit, the adaptive joint demodulation unit being responsive to the mode control signal to place the adaptive joint demodulation unit into one of a joint demodulation mode and a single user demodulation mode.

43. The communication apparatus as recited in claim 37, wherein the received signal is a communication signal received over a wireless communication network and the communication apparatus is one of a mobile terminal and a base transceiver station.

44. The communication apparatus as recited in claim 37, further comprising:
a demodulation unit that generates the sequence of symbols responsive to the received signal.

45. The communication apparatus as recited in claim 37, further comprising:
a decoding unit that generates a sequence of decoded symbols associated with the received signal responsive to the sequence of symbols;
wherein the fixed information detection unit is responsive to the sequence of decoded symbols;
wherein the averaging unit generates an average decoded symbol value across the plurality of time slot intervals for the respective one of the plurality of symbol positions responsive to the sequence of decoded symbols; and
wherein the fixed symbol estimation unit generates the fixed symbol control signal that identifies whether the respective one of the plurality of symbol positions contains the fixed symbol responsive to the average decoded symbol value generated for the respective one of the plurality of symbol positions.

46. A communication apparatus, comprising:
a fixed information detection unit that is responsive to a received sequence of symbols associated with a signal received across a plurality of time slot intervals, the fixed information detection unit comprising:
an averaging unit that generates average values across the plurality of time slot intervals for respective ones of the plurality of symbol positions responsive to the received signal; and
a known information detection unit that generates an output signal indicative of whether the received signal contains fixed symbols corresponding to a predefined symbol sequence responsive to the average values generated for the respective ones of the plurality of symbol positions.

47. The communication apparatus as recited in claim 46, further comprising:
a demodulation unit that generates the received sequence of symbols responsive to the received signal and the output signal from the known information detection unit.

48. The communication apparatus as recited in claim 47, wherein the demodulation unit is a joint demodulation unit, the received signal comprises a desired signal and an interfering signal, and the received sequence of symbols are associated with the interfering signal.

49. The communication apparatus as recited in claim 48, wherein the joint demodulation unit is an adaptive joint demodulation unit.

50. The communication apparatus as recited in claim 49, further comprising a control unit that generates a mode control signal responsive to the output signal from the known information detection unit, the adaptive joint demodulation unit being responsive to the mode control signal to place the adaptive joint demodulation unit into one of a joint demodulation mode and a single user demodulation mode.

51. The communication apparatus as recited in claim 46, wherein the received signal is a communication signal received over a wireless communication network and the communication apparatus is one of a mobile terminal and a base transceiver station.

52. The communication apparatus as recited in claim 46, further comprising:
a demodulation unit that generates the sequence of symbols responsive to the received signal.

53. The communication apparatus as recited in claim 46, further comprising:
a decoding unit that generates a sequence of decoded symbols associated with the received signal responsive to the sequence of symbols;
wherein the fixed information detection unit is responsive to the sequence of decoded symbols;
wherein the averaging unit generates average decoded symbol values across the plurality of time slot intervals for the respective ones of the plurality of symbol positions responsive to the sequence of decoded symbols; and
wherein the known information detection unit generates the output signal indicative of whether the received signal contains the fixed symbols corresponding to the predefined symbol sequence responsive to the average decoded symbol values generated for the respective ones of the plurality of symbol positions.

54. A communication apparatus, comprising:
means for receiving a signal across a plurality of time slot intervals, respective ones of the plurality of time slot intervals having a plurality of symbol positions associated therewith to provide a sequence of symbols associated with the received signal in respective ones of the plurality of symbol positions;
means for determining an average value across the plurality of time slot intervals for a respective one of the plurality of symbol positions; and
means for determining whether the respective one of the plurality of symbol positions contains a fixed symbol based on the average value determined for the respective one of the plurality of symbol positions.

55. The communication apparatus as recited in claim 54, wherein the means for determining whether the respective one of the plurality of symbol positions contains a fixed symbol based on the average value determined for the respective one of the plurality of symbol positions comprises:
means for comparing the average value determined for the respective one of the plurality of symbol positions with a symbol threshold value.

56. A communication apparatus, comprising:
means for receiving a signal across a plurality of time slot intervals, respective ones of the plurality of time slot intervals having a plurality of symbol positions associated therewith to provide a sequence of symbols associated with the received signal in respective ones of the plurality of symbol positions;
means for determining average values across the plurality of time slot intervals for respective ones of the plurality of symbol positions; and
means for determining whether the received signal contains symbols corresponding to a predefined symbol sequence based on the average values determined for the respective ones of the plurality of symbol positions.

57. The communication apparatus as recited in claim 56, wherein the means for determining whether the received signal contains symbols corresponding to the predefined symbol sequence based on the average values determined for respective ones of the plurality of symbol positions comprises:
means for comparing the average values determined for the respective ones of the plurality of symbol positions with the predefined symbol sequence to provide a correlation value; and
means for comparing the correlation value with a correlation threshold value.

58. A computer program product for processing a received signal, comprising:
a computer readable storage medium having computer readable program code embodied therein, the computer readable program code comprising:
computer read able program code for receiving the signal across a plurality of time slot intervals, respective ones of the plurality of time slot intervals having a plurality of symbol positions associated therewith to provide a sequence of symbols associated with the received signal in respective ones of the plurality of symbol positions;
computer readable program code for determining an average value across the plurality of time slot intervals for a respective one of the plurality of symbol positions; and
computer readable program code for determining whether the respective one of the plurality of symbol positions contains a fixed symbol based on the average value determined for the respective one of the plurality of symbol positions.

59. The computer program product as recited in claim 58, wherein the computer readable program code for determining whether the respective one of the plurality of symbol positions contains a fixed symbol based on the average value determined for the respective one of the plurality of symbol positions comprises:
computer readable program code for comparing the average value determined for the respective one of the plurality of symbol positions with a symbol threshold value.

60. A computer program product for processing a received signal, comprising:
a computer readable storage medium having computer readable program code embodied therein, the computer readable program code comprising:
computer readable program code for receiving the signal across a plurality of time slot intervals, respective ones of the plurality of time slot intervals having a plurality of symbol positions associated therewith to provide a sequence of symbols associated with the received signal in respective ones of the plurality of symbol positions;
computer readable program code for determining average values across the plurality of time slot intervals for respective ones of the plurality of symbol positions; and
computer readable program code for determining whether the received signal contains symbols corresponding to a predefined symbol sequence based on the average values determined for the respective ones of the plurality of symbol positions.

61. The computer program product as recited in claim 60, wherein the computer readable program code for determining whether the received signal contains symbols corresponding to the predefined symbol sequence based on the average values determined for respective ones of the plurality of symbol positions comprises:
computer readable program code for comparing the average values determined for the respective ones of the plurality of symbol positions with the predefined symbol sequence to provide a correlation value; and
computer readable program code for comparing the correlation value with a correlation threshold value.
